(19) United States
(12) Patent Application Publication
(10) Pub. No.: US 2026/0230320 A1
(43) Pub. Date: Aug. 6, 2026

(54) READER AND ENCRYPTION DEVICE BINDING WITH COMPUTER

(71) Applicant: VISA INTERNATIONAL SERVICE ASSOCIATION, San Francisco, CA (US)

(72) Inventors: Yuexi Chen, Foster City, CA (US); Mustafa Top, San Ramon, CA (US)

(73) Assignee: Visa International Service Association, San Francisco, CA (US)

(21) Appl. No.: 19/157,991

(22) PCT Filed: Feb. 26, 2024
(86) PCT No.: PCT/US2024/017267

§ 371 Date: Aug. 19, 2025

Related U.S. Application Data
(60) Provisional application No. 63/487,511, filed on Feb. 28, 2023.

(51) Int. Cl. H04L 9/14; H04L 9/32

(52) U.S. Cl. CPC H04L 9/14; H04L 9/3247

(57) ABSTRACT

Methods and systems for establishing a cryptographic binding between a secure element of a reader and a driver of a communication device are disclosed. Such a cryptographic binding can enable data (e.g., credentials) read or otherwise acquired by the reader to be securely transmitted to the driver of the communication device, and can prevent interception of those data using e.g., packet sniffing or protocol analysis malware as those data are transmitted over components of the communication device, such as a communication bus. The communication device can use the driver to verify the secure element of the reader using identification data associated with the secure element. Upon successful verification, the communication device can establish a mutual secret key between the secure element of the reader and the driver, thereby enabling encrypted communication between the two.

### CROSS-REFERENCE TO RELATED APPLICATIONS

This application is a PCT application which claims priority to U.S. Provisional Application No. 63/487,511, filed on Feb. 28, 2023, which is herein incorporated by reference in its entirety.

### BACKGROUND

Generally, improvements to computer systems, including communication devices (e.g., network connected devices such as smartphones, laptops, tablets, desktop computer systems, etc.), have resulted in considerably expanded functionality of those devices, and an increasing number of peripherals, communications interfaces, and integrated components or devices. Twenty years ago, a cell phone may have included a cellular antenna as its only communication interface. Now, a smartphone may possess a cellular antenna, a Bluetooth antenna, a near field communication (NFC) antenna, a USB port, an optical scanner (implemented using, e.g., an integrated camera), a biometric scanner, and countless other interfaces that the smartphone can use to receive data from the world at large.

These improvements have made it easier for individuals and organizations to perform task that might have previously required specialized hardware. For example, an entertainment venue (e.g., a concert hall, sport stadium etc.,) does not need specialized ticket scanning hardware in order to verify customer tickets before admitting those customers to the venue. Instead, employees can scan tickets with an off-the-shelf smartphone (which may even be the employee's personal property) using an integrated camera and an associated ticket scanning application. As another example, a small business owner may be able to use their personal tablet or smartphone as a point of sale (POS) terminal using a compact and inexpensive credit card reader attachment, eliminating the need for a specialized point of sale terminal.

However, these improvements have also lead to new data security risks. The communication interfaces of communications devices, including internal communication interfaces such as system busses, present a security vulnerability. As data is transmitted between device components or peripherals (e.g., between a Bluetooth receiver and a processor) on such communication interfaces, it is vulnerable to interception. For example, packet analyzing malware can be used to intercept data sent over a universal serial bus (USB) between a peripheral device and a device driver used by a computer system to communicate with that peripheral device. Using such software, an eavesdropper or other malicious entity can extract and steal this potentially sensitive data.

This interception risk can be particularly problematic for access systems comprising communications devices and integrated reader devices. For example, a property management group may use a communication device (e.g., a computer system) with an integrated smartcard reader in order to control access to an apartment building. A resident of that apartment building could swipe their ID card through the reader in order to supply a credential to the communication device. The communication device can verify the credential in order to verify that user has access to the building (e.g., using a resident database). After verifying the credential, the communication device can e.g., unlock an electronic lock on the building door, enabling the user to enter.

However, if a malicious entity can intercept the credential, e.g., using malware that intercepts data transmitted via an internal system bus of the communication device, that malicious entity can steal the credential and later use it to impersonate that resident, e.g., by loading the stolen user credential onto a counterfeit ID card, and using that counterfeit ID card to impersonate the resident and gain access to their apartment.

Embodiments address this problem and other problems, individually and collectively.

### SUMMARY

Embodiments of the present disclosure are directed to methods and systems for establishing a cryptographic binding between a reader and a driver application on a communication device (e.g., a network connected communication device such as a smartphone, laptop, tablet, wearable device, etc.). The cryptographic binding can enable the secure transmission of data between the reader and the driver, preventing potential interception and theft, as described above.

Generally, drivers can comprise software that can be used by a communication device to communicate, interface, or otherwise control other connected devices, which can include integrated components of the communication device. For example, a communication device with an integrated NFC reader can use a device driver to receive and interpret data from the NFC reader over a system bus or other communication interface.

However, in conventional communication devices, data (such as credentials) is transmitted in the clear between readers and communication devices. As a consequence, such data is vulnerable to interception. For example, USB sniffing malware, USB protocol analyzers, and USB over IP systems can be used to surreptitiously acquire USB payloads, and therefore steal any data contained in those USB payloads.

By contrast, embodiments of the present disclosure provide for methods and systems (including communication devices and readers) for enabling secure cryptographic communication between a reader and a communication device by binding a reader with a secure element (e.g., a secure cryptoprocessor) to a host communication device, thereby creating an encryption tunnel between the two devices. This can be accomplished by establishing a mutual secret key between a driver of the communication device and the secure element of the reader. The reader can encrypt data using the mutual secret key and transmit the encrypted data to the driver. The driver can decrypt that data using the mutual secret key, and then process it.

For example, the reader could comprise an NFC smartcard reader that uses near field communication to read a credential (e.g., a user identifier) stored on a care such as an ID card. Such a reader could be directly integrated into a communication device (e.g., connected to the other components of the communication device via an integrated I2C bus) or could comprise a removable device that plugs into the communication device (e.g., via a USB port). The reader can encrypt this credential using the mutual secret key. The reader can transmit the encrypted credential to a driver running on a communication device, e.g., as a payload over a communication interface of the communication device, such as a USB interface. The driver can then decrypt the credential using the mutual secret key, and can process the credential, e.g., in order to verify the identity of the cardholder in order to admit them to an access controlled location (such as a secure building).

Encrypting the credential using the mutual secret key prevents the credential from being intercepted within the communication device itself. An eavesdropper could conceivably corrupt the communication device by surreptitiously installing “sniffing” malware (e.g., USB sniffing software or a USB protocol analyzer) on the communication device. In a conventional communication device, such malware could be used to intercept and steal the credential, potentially enabling the eavesdropper to, e.g., clone the credential to a new smartcard user device and impersonate the legitimate user device owner. However, in embodiments, because the credential is encrypted using the mutual secret key, any potential eavesdroppers would acquire the encrypted credential, not the credential itself. As a result, embodiments of the present disclosure protect potentially sensitive data, such as credentials, from being stolen as they are transferred from devices such as readers to communication devices.

In more detail, one embodiment is directed to a method performed by a communication device. The communication device can establish a mutual secret key between a driver and a secure element. Later, the communication device can use the driver to receive an encrypted credential from a reader associated with the communication device. This encrypted credential can comprise a credential received by the reader from a user device that has been encrypted using the mutual secret key. The communication device can use the driver to decrypt the credential using the mutual secret key, thereby producing the credential in plain text. The communication device can then process the credential using the driver.

Another embodiment is directed to a method performed by a reader. The reader can use a secure element to establish a mutual secret key between a driver of a communication device and the secure element. Later, the reader can receive a credential from a user device. The reader can use the secure element to encrypt the credential using the mutual secret key, thereby producing an encrypted credential. The reader can use the secure element to transmit the encrypted credential to the communication device. The communication device can decrypt the encrypted credential using the driver and the mutual secret key, thereby producing the credential. The communication device can then process the credential using the driver.

In some embodiments, the reader and communication device can perform a mutual authentication process in order to establish the mutual secret key, which can be stored in their respective secure elements (e.g., secure cryptoprocessing chips) and can be used by those secure elements to perform encryption and decryption operations. In such embodiments, the communication device can retrieve information such as a digital signature and a public key from the secure element of the reader. This information can be provided by the communication device to an online authority computer, which can verify the reader's secure element based on this information. Such an online authority computer could correspond to a device manufacturer of the reader or the secure element of the reader. After the reader's secure element is verified, the reader's secure element and the driver can establish the mutual secret key, e.g., using a key exchange method such as a Diffie-Hellman key exchange.

Some other embodiments are directed to computer systems or other devices (e.g., communication devices) that can be configured to perform the methods described above or other methods. For example, one embodiment is directed to a communication device comprising one or more processors and a non-transitory computer readable medium coupled to the one or more processors. The non-transitory computer readable medium can comprise instructions that, when executed by the one or more processors, cause the one or more processors to perform the method described above (or other methods described in the detailed description below).

### Terms

A “server computer” may include a powerful computer or cluster of computers. For example, a server computer can include a large mainframe, a minicomputer cluster, or a group of servers functioning as a unit. In one example, a server computer can include a database server coupled to a web server. A server computer may comprise one or more computational apparatuses and may use any of a variety of computing structures, arrangements, and compilations for servicing the requests for one or more client computers.

A “memory” may include any suitable device or devices that may store electronic data. A suitable memory may comprise a non-transitory computer readable medium that stores instructions that can be executed by one or more processors to implement a desired method. Examples of memories include one or more memory chips, disk drives, etc. Such memories may operate using any suitable electrical, optical, and/or magnetic mode of operation. A “memory buffer” can include a region of memory used to temporarily store data.

A “processor” may include any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or XScale; and/or the like processor(s).

A “user” may include an entity that uses something for some purpose. An example of a user is a person who uses a “user device” or a “mobile device.” A user device may include any device operated by a user, such as a smartphone, smartcard (including payment cards such as credit cards), wearable device, laptop, tablet desktop computer, etc. A “mobile device” may include a device that is mobile, such as a smartphone, smartcard, smartwatch, other wearable device, etc. A mobile device may also be used by a user. Many mobile devices can be user devices, and likewise many user devices can be mobile devices. Generally the terms user device and mobile device are used herein to differentiate between two devices when two devices are present in a system or used in a method. User devices and mobile devices may comprise “electronic elements,” e.g., integrated circuit chips, capacitors, resistors, etc.

A “resource provider” may include an entity that provides a “resource.” A “resource” which may include something which can be provided. Examples of resources include material resources, such as iron, monetary resources, such as dollars, and consumer goods, such as cleaning supplies, clothing, food, etc. Resources may also include services, such as cleaning services. Access to something may also qualify as a resource, e.g., access to a secure building. Examples of resource providers include merchants, government entities, guards, etc. A resource provider may operate a “resource provider computer.”

A “transport computer” may include a computer that transports data from one computer to another computer. A transport computer may comprise an intermediary in a computer network such as the Internet. In some cases, a transport computer may be operated by an “acquirer” or “acquiring bank,” an entity that performs banking services on behalf of a resource provider (e.g., a merchant).

An “authorization computer” may include a computer system that is used to authorize some action or interaction between entities. For example, an authorization computer can be used to authorize a transaction between a user and a (merchant) resource provider. In some cases, an authorization computer may be operated by an “issuer” or “issuing bank,” an entity that performs banking services on behalf of a user. The owner or operator of an authorization computer may be referred to as an authorizing entity. For example, an issuing bank can comprise an authorizing entity.

An “authorization request message” may include a message sent to an authorization computer, requesting authorization for some action or interaction. For example, an authorization request message can request authorization for a transaction conducted between a (merchant) resource provider and a user. As another example, an authorization request message can request authorization to grant a user access to a secure facility, e.g., a government laboratory. An “authorization response message” may include a message sent by an authorization computer that is responsive to an authorization request message. An authorization response message can, for example, confirm or deny authorization. Authorization request and response messages can conform to any appropriate communication protocol or standard, including ISO 8583, a standard for exchanging payment card information.

A “processing computer” may include a computer system that processes data or messages transmitted between computers in a network. As an example, a processing computer can receive messages, determine their intended recipient, and transmit those received messages to their intended recipient. A processing computer can comprise part of a “processing network,” such as a payment processing network.

A “communication device” may include a computer system or other device that performs communication as one of its functions. For example, a communication device can comprise a hardware device capable of transmitting an analog or digital signal either wirelessly or over a wired network. Examples of communication devices include smartphones, wearable devices, laptops, tablets, desktop computers, etc. A communication device may communicate with other devices directly or over a “communication network” (e.g., the Internet, a cellular network, a local area network, etc.). A communication device may use one or more “communication interfaces” to communicate with other devices. Communications interfaces can comprise electronic circuits or other hardware elements that enable machines, devices, and computers to communicate with other machines, devices, and computers, often either wirelessly or using wired interconnections. USB, I2C, SATA, Ethernet, Bluetooth, near field communication (NFC) receivers, etc. are all examples of communication interfaces.

An “integrated device” may include a device that is part of another device, and which may facilitate the operation of the other device. For example, a computer system may include an integrated graphics card, a computing chip specifically used for graphical processing. In some cases, an integrated device may be housed in, or otherwise affixed to the device that it is integrated in. For example, an integrated graphics card may be mounted onto the motherboard of a laptop computer, and an integrated NFC reader may be housed in the casing of a smartphone.

A “reader” may include a device that “reads” data, e.g., from another device or from some other data source. For example, a QR code reader may comprise a camera or optical sensor capable of reading data from printed QR codes. As another example, an NFC reader may comprise an NFC interface that can be used to read data from an NFC enabled smartcard. As yet another example, a reader could comprise a “chip card reader”, which includes conductive contacts used to interface with conductive contacts on smartcard user devices. In some cases, a reader can be part of an “access device”, which may include a device used to access something, such as a network or computer system. For example, a point of sale terminal can comprise an access device used to gain access to a payment processing network.

A “credential” may include any data (e.g., an identifier) which may be used to qualify or identify something, such as an entity, computer, device, account, etc. Examples of credentials include names, social security numbers, serial numbers, SIM numbers, credit card numbers, account numbers, usernames, etc. A user device credential may include an identifier that can be used to identify a particular user device.

### BRIEF DESCRIPTION OF THE DRAWINGS

FIG. 1 shows a block diagram of an exemplary system comprising a communication device, a reader, and a user device according to some embodiments.

FIG. 2 shows a diagram of a first exemplary user device according to some embodiments.

FIG. 3 shows a diagram of a second exemplary user device according to some embodiments.

FIG. 4 shows a block diagram of an exemplary communication device and reader according to some embodiments.

FIG. 5 shows a block diagram of an exemplary communication device with an integrated reader according to some embodiments.

FIG. 6 shows a sequence diagram corresponding to an exemplary method according to some embodiments.

### DETAILED DESCRIPTION

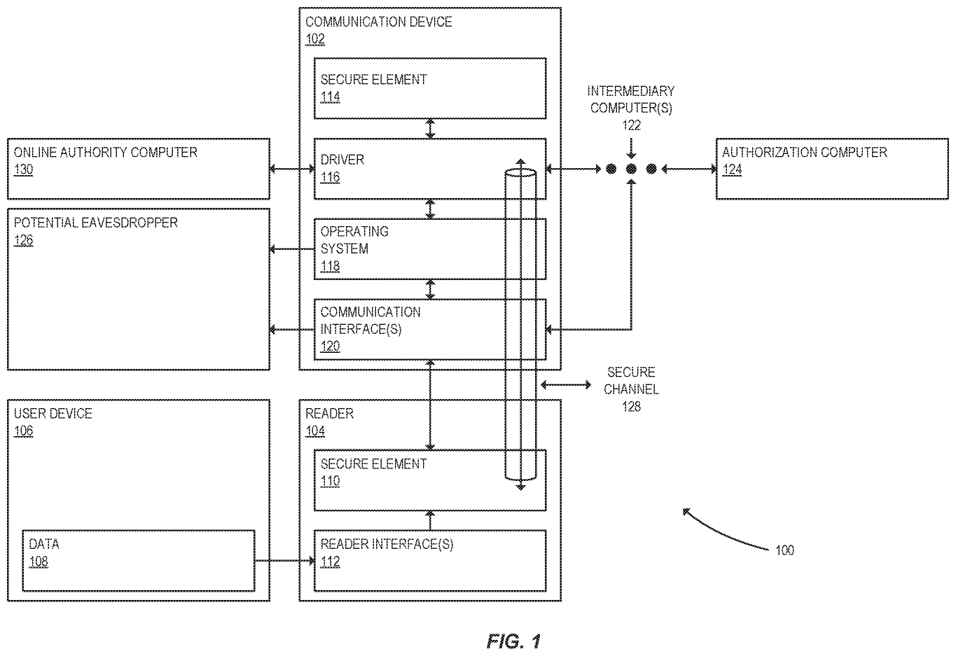

Systems according to embodiments may be better understood with reference to FIG. 1, which shows an exemplary system 100 comprising a communication device 102, a reader 104, and a user device 106.

In system 100, communication device 102 can use reader 104 to read data 108 (e.g., a credential) from user device 106, and process that data for some purpose. By establishing a cryptographic binding, the reader 104 and the communication device 102 can create a secure channel 128 over which encrypted data can be transmitted, preventing a potential eavesdropper 126 from intercepting that data via operating system 118 or communications interface(s) 120. The system 100 also comprises some other computers and entities, including an authorization computer 124 and an online authority computer 130, described in more detail below.

The devices and computers in the system 100 can communicate with one another using a communication network (not pictured), such as a cellular communication network or the Internet. For example, the communication device 102 can communicate with the intermediary computer(s) 122, the authorization computer 124, and the online authority computer 130 over the Internet. However, it should be understood that such a communication network can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers and devices in system 100 may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like. When communicating over a network such as the Internet, there is a reasonable probability that messages or other data sent between two computers or devices in the system 100 may be routed between an indeterminate number of intermediary computer(s) 122 pictured in FIG. 1.

In some embodiments, communication device 102 and reader 104 may be operated by a resource provider or the user of the user device 108. As an example, a resource provider operating communication device 102 and reader 104 can use communication device 102 and reader 104 to securely receive and process a credential (e.g., data 108) from user device 106, in order to verify that a user corresponding to user device 106 is eligible to receive a resource. If the user is successfully authorized to receive the resource, the resource provider can then provide the user with that resource.

One example of a resource is access to a secure or otherwise access-controlled location. An example of such a location is a government facility. In this example, the user device 106 could comprise a smart ID card and the reader 104 could comprise a device that interfaces with the smart ID card. The reader 104 can be connected to the communication device 102, which could comprise a computer system operated by a resource provider (e.g., a guard who is guarding the entrance to the access-controlled location), and the intermediate computer(s) 122 or the authorization computer 124 could comprise part of a computer network for the building. In this example, the system 100 (e.g., using the authorization computer 124 can be used to authenticate the user based on the credential from their user device 106, and thereby verify that the user has access to the government facility. If the user is successfully authenticated, the guard can grant the user access, e.g., by unlocking a door. If the user is not successfully authenticated, the guard can take any appropriate steps, e.g., asking the user to leave, offering the user a chance to re-attempt authentication, etc.

Another example of a resource is a good or service provided by a merchant resource provider. In such a case, the system 100 can be used to authenticate a user in order to verify that the user is authorized to perform a transaction with the merchant. In this example, the user device 106 can comprise an NFC enabled payment card storing comprising a payment credential (e.g., data used to enact a payment transaction, such as a primary account number (PAN), a card verification value (CVV or CVV2), an EMV cryptogram, etc.), the reader 104 can comprise an NFC reader used to retrieve the credential from the user device 106, and the communication device 102 could comprise a merchant device (e.g., a smartphone, laptop, or tablet owned by the merchant) connected to the reader 104.

In this example, the intermediary computer(s) 122 could include computers associated with four party network, a system used to enact credit card transactions, and could include, for example, a transport computer and a processing computer. In such a case, the transport computer could comprise a computer system that transports messages, request messages, and authorization request messages to the processing computer. In some embodiments, the transport computer can comprise an acquirer computer associated with an acquiring bank, which can maintain an account corresponding to a merchant resource provider (e.g., the operator of communication device 102 and reader 104). Later (assuming authorization of the transaction between the user of user device 106 and the resource provider operator of communication device 102 and reader 104), the transport computer may be involved in a clearing and settlement process, used to enact a transfer of funds from the user of user device 106 to the resource provider associated with communication device 102. Alternatively, the transport computer can comprise a merchant gateway server, or any other appropriate computer system used to transmit messages, request messages, and/or authorization request messages to a processing computer.

A processing computer (sometimes referred to as a processing server) can comprise a computer system that performs a variety of message and data processing functions. Particularly, a processing computer can route data and messages (including request messages and/or authentication request messages) to their intended recipients. As an example, a processing computer can identify the intended authorization computer recipient of an authorization request message, and transmit the authorization request message to that authorization computer. In some embodiments, processing computer may be associated with a payment processing network (such as VisaNet™), and may assist in processing credit and debit card transactions by routing authorization request messages to issuer bank computers.

Continuing the example, the communication device 102 could generate or initiate the generation of an authorization request message comprising the credential and transmit the authorization request message to authorization computer 124 via intermediate computer(s) 122 using driver 116. The authorization computer 124 can analyze the authorization request message and determine whether or not to authorize the transaction between the merchant operator of communication device 102 and the user of user device 106. Such analysis can include risk evaluation, and can include evaluating a transaction amount, the time of the transaction, the recent frequency of transactions, etc. Authorization computer 124 can generate an authorization response message, indicating whether the transaction has been approved or denied. This authorization response message can be returned to the communication device 102 via intermediary computer(s) 122.

Many of the entities, computers and devices in system 100 are described in further detail with reference to the other figures. Additionally, many of these computers and devices can be understood contextually based on the description above. However, for the sake of completeness, these entities, computers and devices are summarized below.

Communication device 102 may comprise a secure element 114, which may comprise a secure cryptoprocessor, which itself may comprise a trusted platform module (TPM), a dedicated cryptographic microcontroller that can be found in some communication devices. In some embodiments, communication device 102 can use secure element 114 to store the mutual secret key established between secure element 110 of reader 104 and driver 116 of the communication device. In such embodiments, secure element 114 (which may be referred to as a “second secure element”) can include a secure memory (sometimes referred to as a “second secure memory”), and the secure memory can store the mutual secret key. The secure element 114 may store other cryptographic keys or perform other cryptographic operations associated with the methods described herein. For example, communication device 102 may use secure element 114 to store a cryptographic key associated with an authorization computer 124. After decrypting an encrypted credential using the mutual secret key, the communication device 102 can use secure element 114 to retrieve the cryptographic key associated with the authorization computer 124, and use it to re-encrypt the credential prior to transmitting it to the authorization computer 124.

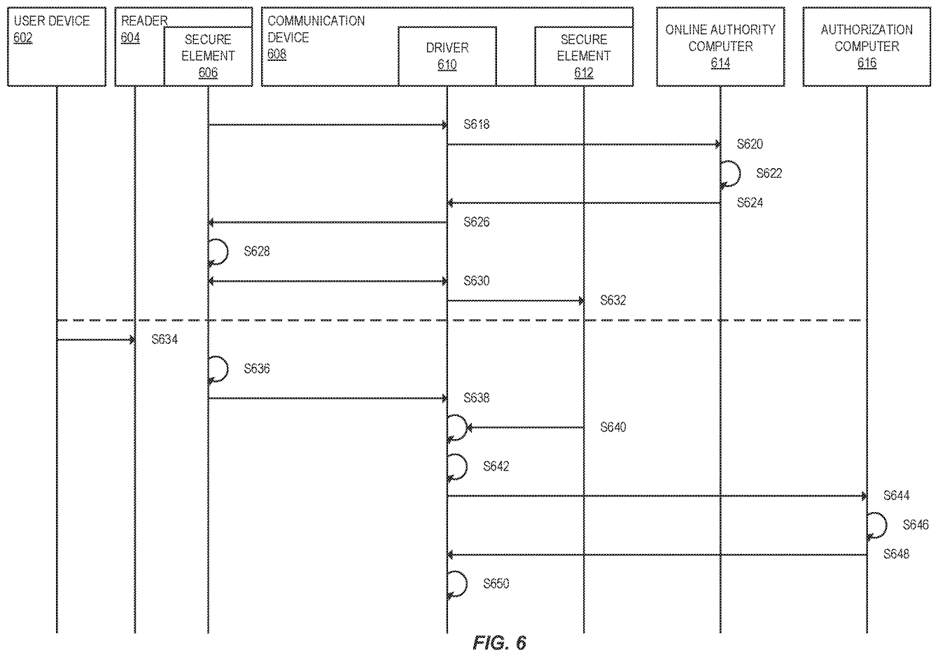

Communication device 102 may additionally operate a driver 116 (sometimes referred to as a “device driver” or a “driver application”), which communication device 102 can use to communicate with and control reader 104. For example, communication device 102 may use driver 116 to receive data, including encrypted credentials from reader 104. Additionally, communication device 102 may use driver 116 to perform various method steps according to embodiments, as described in more detail below with reference to FIG. 6. For example, communication device 102 may use driver 116 to establish a mutual secret key between secure element 110 of reader 104 and the driver 116. To accomplish this, communication device 102 may use driver 116 to communicate with an online authority computer 130, e.g., by providing the online authority computer 130 with information (such as public keys, secure element identifiers, digital signatures, etc.) that can be used by the online authority computer 130 to validate secure element 110 as part of establishing the mutual secret key.

Operating system 118 can comprise system software that can be used by communication device 102 to manage hardware and software resources of communication device 102. Communication device 102 can use operating system 118 to operate driver 116 and other software module operated by the communication device 102 (e.g., general purpose computing software, such as web browsers), e.g., by scheduling processor time to those software modules and allocating memory for those software modules. Operating system 118 may have access to components of the communication device 102, including communication interface(s) 120 and secure element 114.

Communication interface(s) 120 may comprise any number of interfaces by which communication device 102 can communicate with other computers, devices, or hardware components, such as reader 104. Examples of communication interfaces include wired interfaces, such as USB, I2C, SPI, SATA, PCI, PCIe, Ethernet, or FireWire, as well as wireless interfaces such as Bluetooth, Wi-Fi, or cellular receivers. Communication device 102 may possess multiple communication interfaces 120.

Conventional communication interfaces (e.g., USB, I2C, SPI, etc.) do not provide a binding or encryption between computers, devices, components, or peripherals. As such, it may be possible for malicious entities, such as a potential eavesdropper 126 to surreptitiously install malware that enables the potential eavesdropper to intercept data via operating system 118 and communication interface(s) 120. For example, USB sniffing software or a USB protocol analyzer could be used to capture data sent by the reader 104 to the communication device 102 via a USB communication interface. However, in embodiments of the present disclosure, a mutual secret key can be established between secure element 110 of reader 104 and driver 116 of communication device 102, thereby enabling those components and software to encrypt messages and other data (e.g., credentials) prior to transmitting those data to one another via the communication interface(s) 120 and operating system 118, effectively establishing a secure channel 128 between secure element 110 and driver 116. Because such data is encrypted, a potential eavesdropper 126 cannot acquire this data in plaintext form, even if they have managed to install sniffing software (or other comparable software) onto communication device 102.

The reader 104 can comprise any device or system capable of interfacing with the user device 106 (e.g., via reader interface 112) and connecting with the communication device 102. In some embodiments, reader 104 may also be part of an “access device.” An example of a reader 104 is a USB connected, NFC-capable point of sale terminal, which can interface with user device 106 (e.g., an NFC enabled credit card) to enable credit card transactions between a user and a resource provider associated with communication device 102. A reader 104 can comprise one or more reader interface(s) 112, such as a magnetic stripe reader, EMV chip interface, near field communication interface, USB interface, Ethernet interface, etc. The reader 104 can use these interfaces to interface with the user device 106 and communicate with the communication device 102.

In general, the reader 104 can collect (e.g., “read”) data 108 from the user device 106, including data comprising credentials. The reader 104 can use a secure element 110 to encrypt a received credential using a mutual secret key, thereby generating an encrypted credential. The reader 104 can provide this encrypted credential to the driver 116 of communication device 102, e.g., via communication interface(s) 120 of communication device 102 and operating system 118.

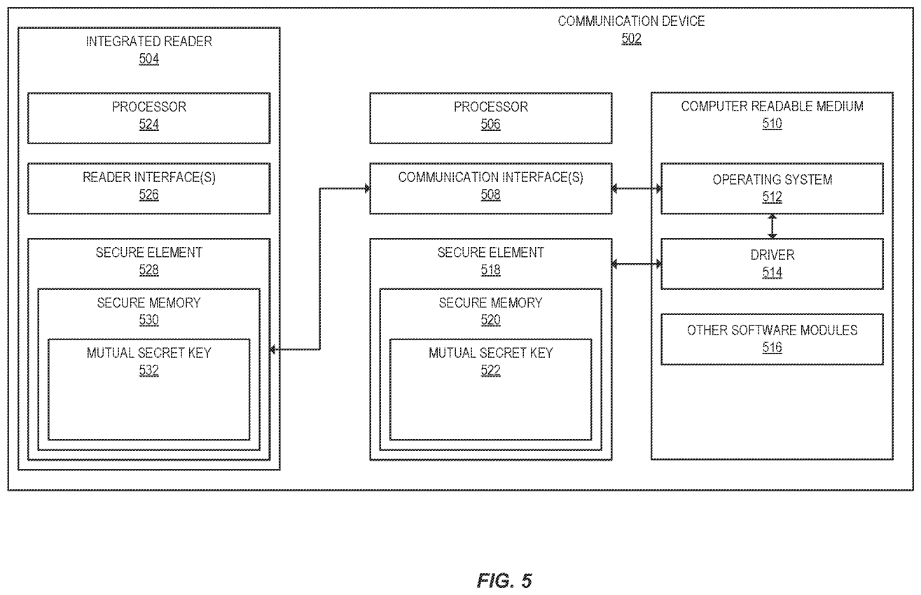

As described above, some personal communication devices include integrated readers e.g., integrated NFC readers, which can allow users to interface their user devices via near-field communication, e.g., by “tapping” a contactless card user device on the reader to complete a payment transaction, such as a remote e-commerce transaction. As such, in some embodiments, reader 104 can comprise an integrated reader, and can comprise a component of the communication device 102. In some embodiments, reader 104 and communication device 102 may comprise a single system, and the reader 104 may be connected to other components of the communication device 102 via an internal system bus communication interface. Such integrated readers are described further below with reference to FIG. 5.

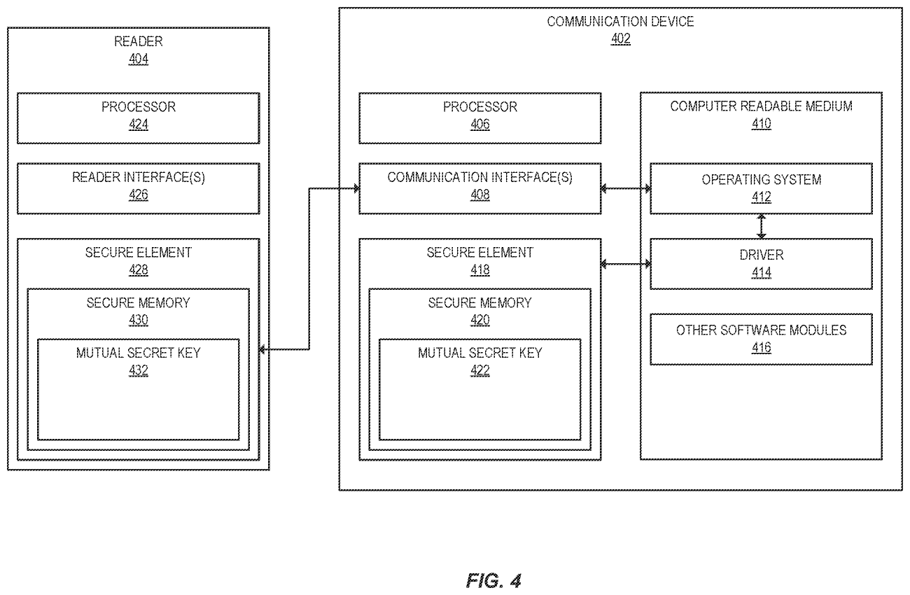

The reader 104 may possess a secure element 110 (sometimes referred to as a “first secure element” in order to differentiate it from secure element 114 of communication device 102). Secure element 110 can comprise a secure cryptoprocessor (e.g., a trusted platform module). As described above, the communication device 102 and reader 104 can establish a mutual secret key between secure element 110 and driver 116, in order to facilitate secure communication between secure element 110 and driver 116. The reader 104 may use secure element 110 for this purpose. For example, the reader 104 can use secure element 110 to provide a secure element identifier, public key, and digital signature to the communication device 102, enabling the communication device 102 to verify the secure element 110 (e.g., using online authority computer 130). Secure element 110 can also be used to verify the driver 116 via a validation token received from communication device 102, and perform a key exchange with driver 116 in order to establish a mutual secret key. Further, reader 104 can use secure element 110 in order to encrypt data (e.g., credentials) received from user device 106 using the mutual secret key, in order to securely transmit that data to communication device 102. In some embodiments, secure element 110 can include a secure memory (e.g., as depicted in FIGS. 4 and 5, and sometimes referred to as a “first secure memory” in order to differentiate it from a “second secure memory”, e.g., a secure memory associated with secure element 114). The secure memory can store the mutual secret key established between the driver 116 and the secure element 110.

Reader interface(s) 112 may comprise any number of interfaces by which reader 104 can communicate with other computers, devices, or hardware component, such as user device 106 as well as communication device 102. Examples of reader interfaces include wired interfaces, such as USB, I2C, SPI, SATA, PCI, PCIe, Ethernet, or FireWire, as well as wireless interfaces such as Bluetooth, Wi-Fi, or cellular receivers. Reader 104 may possess multiple reader interfaces 112. As an example, reader 104 may read a credential (or other data 108) from user device 106 via an NFC interface, and can communicate with communication device 102 via a USB interface.

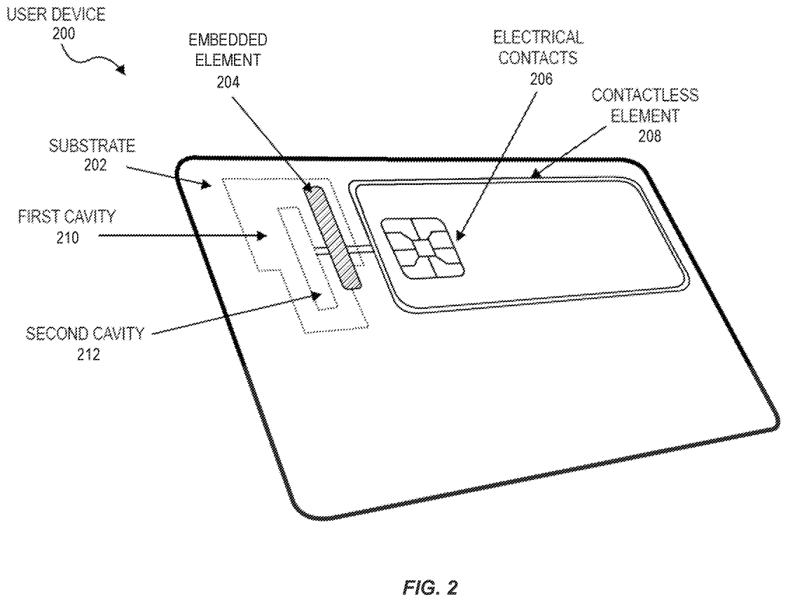

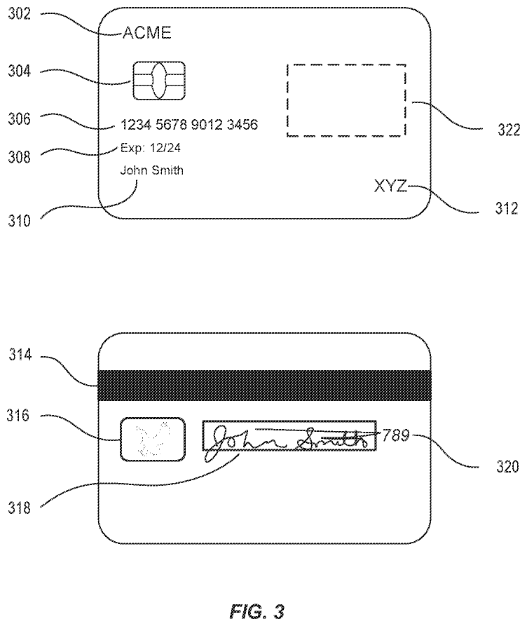

User device 106 can comprise a device operated by a user, such as a smartcard, smartphone, wearable device (e.g., a smartwatch), a laptop, a tablet, a desktop computer, etc. In some embodiments, user device 106 can be in the form of a card, such as a smartcard or a payment card. User device 106 can store data 108, which may include credentials. Such credentials may be processed by communication device 102 as part of some interaction. For example, as described above, a credential may be processed by communication device 102 in order to verify that a user of user device 106 has access to a secure building. Alternatively, the credential could comprise a payment credential that can be used to enact a payment transaction between a user of user device 106 and a merchant operator of communication device 102 and reader 104. User devices are described in more detail with reference to FIGS. 2 and 3 below.

Intermediary computer(s) 122 may comprise any number of computers through which messages from the communication device 102 may be transmitted through on route to authorization computer 124, e.g., computer systems on the Internet. Alternatively or additionally, intermediary computer(s) 122 may comprise computer systems in a four-party network, such as a transport computer and a processing computer, as described above.

Authorization computer 124 may comprise a computer system that authorizes authorization request messages received from communication device 102 via a processing computer (or any other communication channel). In transaction processing systems, authorization computer 124 may comprise an issuer computer associated with an issuing bank, which may have issued the user device 106 (e.g., credit card) to a user. Authorization computer 124 may use the contents of received authorization request messages in order to generate authorization response messages. These authorization response messages may indicate whether users are authorized to perform some actions (e.g., complete transactions) or access some resources. Authorization response messages may be transmitted by the authorization computer 124 back to communication device 102 via intermediary computer(s) 122.

The online authority computer 130 (sometimes referred to as an “online control authority”) can comprise a computer system that can verify the legitimacy of the secure element 110. In some embodiments, the online authority computer 130 can comprise a computer system associated with a manufacturer of the reader 104 and/or the secure element 110. For example, the online authority computer 130 may comprise a web server that maintains a database of secure element identifiers (e.g., serial numbers) along with other information that can be used to validate readers and/or secure elements, such as reader 104 and/or secure element 110. Upon verifying the secure element 110, the online authority computer can provide a token (sometimes referred to as a “verification token” or “validation token”) that can be returned to the reader 104 via communication device 102. Such a token can be used to establish a mutual secret key between secure element 110 and driver 116.

User devices, communication devices, and readers are described in more detail below with reference to FIGS. 2-5. As described above, the user device 106 may be in the form of a card, e.g., a smartcard or payment card, such as a credit card. FIG. 2 shows an exploded-view illustration of a smart card user device 200 according to some embodiments. The user device 200 can comprise a substrate 202 (such as a plastic) in which the other components are embedded. These components can include an embedded element 204, electrical contacts 206 and contactless element 208, which may be referred to more generally as “electrical elements.” The substrate 202 may contain a first cavity 210 and a second cavity 212, which may accommodate the components listed above.

The embedded element 204 may comprise an embedded component of user device 200, which may be embedded within substrate 202. For example, embedded element 204 may comprise a smart-card embedded microcontroller. Such a smart-card embedded microcontroller can comprise various computing components, including (as examples) a CPU core, memory (such as ROM, RAM, EEPROM, FLASH, etc.), an EEPROM oscillator, a charge pump, a modular arithmetic processor, control logic, an interrupt controller, a phase locked loop (PLL), a random number generator, a time base and a watchdog, among any other suitable components. Embedded element 204 may additionally include a cryptographic co-processor, which may be used to perform cryptographic operations. Memory of embedded element 204 may store data such as credentials which can be used in some methods according embodiments. These credentials can include, for example, a user device identifier (e.g., an account number associated with the user device), a user identifier, or a payment account number, e.g., a 15 to 19 digit credit card number. Such a credential can be used to, e.g., authorize an interaction (e.g., a transaction) between a user of the user device and a merchant operator of a reader and communication device. In some cases, the embedded element 204 may be powered by a transmission of power from a reader or access device interfacing with the user device 200.

Electrical contacts 206 and contactless element 208 may comprise user device interfaces, which can be used by user device 200 to communicate or interface with other devices, such as a reader. Using the electrical contacts 206 and/or contactless element 208, a reader can communicate with embedded element 204, e.g., in order to read data (such as a credential) from the memory of embedded element 204. In some embodiments, contactless element 208 can comprise a near-field communication antenna, by which a reader can communicate with the user device 200 via near-field communication. These user device interfaces and embedded element 204 may comprise part of an “integrated chip circuit”, “chip circuit”, or “smart chip”. As such, user device 200 may be referred to as a “chip card”.

Similarly, FIG. 3 shows two sides of the exterior view of an exemplary user device according to some embodiments. In FIG. 3, the exemplary user device comprises a credit card (a type of payment card), which may include an issuer identifier 302 that provides an indication of the authorizing entity backing the user device. In some embodiments, the issuer identifier 302 may include a name or logo of the authorizing entity, which may comprise an issuing bank.

The user device may include an integrated circuit chip 304 (sometimes referred to as a “smart chip”). The surface metal contacts of the integrated chip circuit 304 may serve as a user device interface. Using this interface, the user device can interface with readers. A user device having an integrated circuit chip may comprise a Europay, Mastercard and Visa (EMV) card. EMV cards can comprise smart cards (also called chip cards or IC cards) that can store their data (e.g., credentials that can be used to authenticate users and authorize credit card transactions) on the integrated circuit chip 304 in addition to magnetic stripes (which may provide backwards compatibility). These include cards that are physically inserted (or “dipped”) into a reader or access device and contactless cards that can be read over a short distance using near field communication or radio-frequency identification (RFID) technology. Like user device 200 from FIG. 2, user device may comprise a contactless element (e.g., contactless element 322), which may be embedded in user device. Contactless element 322 can comprise, for example, an NFC antenna, or other suitable means for enabling the contactless transmission of data from user device to a reader or access device. Payment cards that comply with the EMV standard are often called “Chip and PIN” or “Chip and Signature” cards, depending on authentication methods employed by the card issuer. The integrated circuit chip 304 may include a processor and/or memory (which may comprise components of a smart-card embedded microcontroller) that includes preloaded instructions. When powered (e.g., by interfacing with a reader or access device), the processor of the integrated circuit chip 304 may begin executing the preloaded instructions, including transmitting or otherwise providing data (including credentials) to a reader or access device. This memory may also include verification data which, when the integrated circuit chip 304 is powered, may be provided to the reader.

The user device may include a user device identifier 306 (e.g., an account number). The user device identifier 306 may comprise a credential. The user device identifier 306 may comprise a 15 to 19 digit number. In some embodiments, the user device identifier 306 may be allocated in accordance with International Standard Organization (ISO) standard 7812. In this standard, the leading six digits of the user device identifier 306 may be the “issuer identification number (IIN)”, sometimes referred to as the “bank identification number (BIN).” The remaining numbers of the user device identifier 306, except the last digit, may be the individual account identification number. The last digit is often a check digit (e.g., a Luhn check digit). The IIN or BIN may be used by a processing network to identify an appropriate authorization entity to which transactions using the user device should be routed.

The user device may include an expiration date 308 that indicates a date after which the user device is no longer valid. In some cases, the user may be required to provide the expiration data to complete a transaction. In the event that the user provides an incorrect expiration date, the transaction may be declined. For example, credit card transactions conducted online or over the phone will often require that the user provide the correct expiration date 308 in order to verify that the user is actually in possession of the credit card. These transactions may be declined if the user is not able to provide the correct expiration date.

The user device may include an account holder name 310 that indicates a user or other entity with which the user device is associated. An authorizing entity may maintain an account for the account holder indicated by the account holder name 310. In some embodiments, a transaction may be declined if a name given in association with the account does not match the indicated account holder name 310.

The user device may include a processing network indicator 312 that indicates a transaction processing network used to route authorization request messages associated with the user device. In some embodiments, merchant may accept user devices associated with certain processing networks. For example, some merchants may only accept user devices associated with Visa.

The user device may include a magnetic strip 314. The magnetic strip 314 may include up to three tracks, known as track 1, track 2, and track 3. In transactions, only track 1 and track 2 are used. The minimum cardholder account information needed to complete a transaction is present on both tracks. Track 1 has a bit density of 210 bits per inch and is the only track that may contain alphabetic text, and hence is the only track that contains the cardholder's name. Track 2 has a bit density of 75 bits per inch.

The user device may include a hologram 316 or other suitable authentication mechanism. A hologram is a mirror-like section that shows a three dimensional image. Holograms are security features which help merchants identify whether a user device is valid or not. Holograms often require expensive equipment to produce and are used to validate the authenticity of the user device based on the unlikelihood that an unauthorized party would be able to replicate the hologram 316.

The user device may include a signature block 318. In some embodiments, the user device must be signed before it may be used in a transaction. During a transaction, the merchant is often supposed to check the signature of the signature block 318 against the signature provided by a user who signs a receipt for the transaction.

The user device may also include a security code 320. A security code 320 might be a CVV, CVV2, CVC, CSC, CID, or any other suitable security code. In a scenario in which the processing network associated with the user device is Visa, MasterCard, or Discover, the security code 320 can comprise a three digit code on the back of the user device. In a scenario in which the processing network associated with the user device is American Express, the security code 320 can comprise a four digit code located on the front of the card. The security code can be used to verify that a user is in possession of a valid user device.

Communication devices and readers according to some embodiments of the present disclosure may be better understood with reference to FIG. 4, which shows an exemplary communication device 402 comprising a processor 406, communications interface(s) 408, computer readable medium 410, and secure element 418. The computer readable medium 410 may be non-transitory and coupled to the processor 406. The computer readable medium 410 may contain instructions, data, code, and/or software modules, which may be used by the communication device 402 to implement some methods according to embodiments. These instructions data, codes, and/or software modules may include an operating system 412, a driver 414, and other software modules 416. FIG. 4 also shows a reader 404 comprising a processor 424, reader interface(s) 426, and a secure element 428.

Processor 424 may comprise any suitable data computation device or devices, which may be able to interpret code and carry out instructions in order to perform the functions of reader 404. Processor 424 may comprise a CPU operating on a reduced instructional set, and may comprise a single or multi-core processor.

Communication interface(s) 408 may comprise any number of interfaces by which communication device 402 can communicate with other computers, devices, or hardware components, such as reader 404. Examples of communication interfaces include wired interfaces, such as USB, I2C, SPI, SATA, PCI, PCIe, Ethernet, or FireWire, as well as wireless interfaces such as Bluetooth, Wi-Fi, or cellular receivers. Communication device 402 may possess multiple communication interface(s) 408. As an example, communication device 402 may communicate with an online authority computer through a cellular interface. As another example, the reader 404 may be connected to the communication device 402 via a USB interface.

Reader interface(s) 426 may comprise any number of interfaces by which reader 404 can communicate with other computers, devices, or hardware component, such as user devices (e.g., smartcard user devices as depicted in FIGS. 2 and 3) as well as communication device 402. Examples of reader interfaces include wired interfaces, such as USB, I2C, SPI, SATA, PCI, PCIe, Ethernet, or FireWire, as well as wireless interfaces such as Bluetooth, Wi-Fi, or cellular receivers. Reader 404 may possess multiple reader interfaces 426. As an example, reader 404 may read a credential from a user device via an NFC interface, and can communicate with communication device 402 via a USB interface.

Secure element 418 can comprise a secure component of communication device 402. In some embodiments, secure element 418 can comprise a tamper-resistant processor chip, such as a secure cryptoprocessor (e.g., a trusted platform module). The secure element 418 may include a secure operating system, and can protect assets, including cryptographic keys such as a mutual secret key 422. The secure element 418 can comprise a secure memory 420 which can store cryptographic assets including the mutual secret key 422. Communication device 402 can also use secure element 418 in order to perform cryptographic operations, such as decrypting encrypted credentials received from reader 404 using mutual secret key 422.

Likewise, secure element 428 can comprise a secure component of reader 404. In some embodiments, secure element 428 can comprise a tamper-resistant processor chip, such as a secure cryptoprocessor (e.g., a trusted platform module). The secure element 418 may include a secure operating system, and can protect assets, including cryptographic keys such as the mutual secret key 432. The secure element 428 can comprise a secure memory 430 which can store cryptographic assets including the mutual secret key 432. Reader 404 can use secure element 428 in order to perform cryptographic operations, such as establishing the mutual secret key between secure element 428 and a driver 414 of communication device 402, as well as encrypt credentials received from user devices using the mutual secret key 432.

Operating system 412 can comprise system software that manages hardware and software resources of communication device 402. Communication device 402 can use operating system 412 to operate driver 414 and other software modules 416, e.g., by scheduling processor time to those software modules and allocating memory for those software modules. The operating system 412 may have access to components of the communication device 402, including communication interface(s) 408 and secure element 418.

Driver 414 can comprise a device driver, a computer program that operates or controls a particular type of device (e.g., reader 404) attached to communication device 402, and can thereby enable communication between communication device 402 and reader 404. The communication device 402 can use driver 414 in order to establish a mutual secret key 422 between driver 414 and secure element 428, thereby enabling secure communication between communication device 402 and reader 404. Further, the communication device 402 can use driver 414 to receive encrypted credentials from secure element 428 and decrypt those credentials using the mutual secret key 422.

Other software modules 416 can include any number of other software modules, code, or instructions that can be used by communication device 402 to perform its functions, including both functions associated with methods according to embodiments and other general purpose computing functions. As described above, communication device 402 may comprise a device such as a laptop, tablet, smartphone, etc., and may therefore perform a variety of general computing functions. For example, communication device 402 may comprise a laptop with a web browser, and the web browser may comprise one of the other software modules 416.

FIG. 4 shows a communication device 402 and a separate external reader 404, attached to the communication device 402 via, e.g., an external communication interface. However, as described above, many personal computing device, including communication devices such as smartphones, may include integrated reader technology, including integrated NFC readers. As such, FIG. 5 depicts a communication device 502 comprising an integrated reader 504, e.g., a communication device 502 where the integrated reader 504 comprises a component of the communication device 502.

Integrated reader 504 could, for example, comprise an integrated USB device, an integrated I2C device, an integrated SPI device, etc. The integrated reader 504 can be connected to other components of communication device 502 via an internal communication interface of communication interface(s) 508, such as an I2C interface, an SPI interface, a SATA interface, a PCI or PCIe interface, or any other appropriate interface for connecting integrated components. In some embodiments, the communication device 502 can comprise a near field communication (NFC) antenna, which can be used by the reader 504 as a reader interface of reader interface(s) 526, e.g., in order to read credentials (or other data) from a user device. As the integrated reader 504 of FIG. 5 comprises a component of the communication device 502, the communication device 502 can further comprise the components of the reader 504, including the processor 524, the reader interface(s) 526, and the secure element 528.

The components, devices, software modules, etc., of FIG. 5 can be generally understood with reference to similar components of FIG. 4, i.e., the function of processor 506 can generally be understood with reference to the description of processor 406 from FIG. 4, and likewise for communication interface(s) 508, computer readable medium 510, operating system 512, driver 514, other software modules 516, secure element 518, secure memory 520, mutual secret key 522, processor 524, reader interface 526, secure element 528, secure memory 530, and mutual secret key 532. As such, description of these components will not be repeated.

Having described user devices, readers, and communication devices according to embodiments, some exemplary methods according to embodiments are described in more detail below with reference to the sequence diagram of FIG. 6. As a broad summary, steps S634-S650 generally comprise steps by which a reader 604 can acquire a credential, encrypt that credential using a mutual secret key, and transmit the encrypted credential to a communication device 608, and by which the communication device 608 can decrypt the credential using the mutual secret key and process the decrypted credential. Steps S618-S632 generally comprise steps by which the reader 604 and communication device 608 can perform a mutual authentication and establish the mutual secret key used in steps S634-S642.

At step S618, the reader 604 can transmit a public key, a digital signature, and a secure element identifier to communication device 608. This data may be stored in or associated with a secure element 606 of the reader 604, which in some embodiments may comprise a near-field communication (NFC) reader configured to receive data from user devices (such as user device 602) via NFC. The communication device 608 can use a device driver (i.e., driver 610) in order to receive this data from the reader 604, e.g., by using software routines associated with the driver 610 to read the public key, the digital signature, and the secure element identifier from the secure element 606 of reader 604. The reader 604 may be connected to the communication device 608 via a communication interface of the communication device 608, and may transmit the public key, digital signature, and secure element identifier via the communication interface. In some embodiments, the reader 604 can comprise a component of the communication device 608. As such, the communication interface can comprise either an external or internal communication interfaces, including USB interfaces, I2C interfaces, SPI interfaces, SATA interfaces, PCI or PCIe interfaces, Ethernet interfaces, Bluetooth interfaces, NFC interfaces, or any other applicable communication interface. Step S618 can occur at any appropriate time. For example, step S618 can be performed upon first discovery of the reader 604 by the communication device 608 (e.g., when the reader 604 is initially “plugged in” to the communication device 608 via, e.g., a USB interface). As another example, step S618 can be performed when the driver 610 is initially loaded or ran on the communication device 608.

At step S620, the communication device 608 can use driver 610 to provide the public key, the digital signature, and the secure element identifier to an online authority computer 614 (which may also be referred to as an “online control authority”). In some embodiments, the online authority computer 614 can comprise a computer system associated with a manufacturer of the reader 604 and/or the secure element 606. The communication device 608 can provide the public key, the digital signature, and the secure element identifier to the online authority computer 614 over a network such as the Internet or via any other appropriate means.

At step S622, the online authority computer 614 can validate the digital signature. In doing so, the online authority computer 614 can verify that the secure element 606 is a legitimate secure element that can be used to perform cryptographic operations. There are a variety of ways that the online authority computer 614 can validate the digital signature. For example, the online authority computer 614 could use the public key to verify that the digital signature was generated with a secret key corresponding to the secure element 606, thereby validating the signature. Additionally, the online authority computer 614 could look up a data record corresponding to the secure element 606 in a secure element database, e.g., using the secure element identifier received from the communication device 608. The online authority computer 614 could use this data record to verify that the public key received from the communication device 608 matches a known secure element public key (e.g., recorded in the data record). After validating the digital signature, the online authority computer 614 can generate a token (which may comprise or be referred to as a “validation token”). This token can indicate that the secure element 606 was successfully validated, and can be used by the reader 604 and communication device 608. The validation token may be a specific data string, or it could be a digital signature produced using a private key of the online authority computer.

At step S624, the online authority computer 614 can provide the token to the communication device 608 via the driver 610. In this way, the communication device 608 can receive the token from the online authority computer 614. The token may be transmitted to the communication device 608 in any suitable form over any suitable network. For example, the token may be encrypted and transmitted to the communication device 608 via a network such as the Internet, and the communication device may decrypt the encrypted token to receive the token. The token may indicate to the communication device 608 that the reader 604 has been successfully validated by the online authority computer 614.

At step S626, the communication device 608 can use the driver 610 to transmit the token to the reader 604. The reader 604 can receive the token using secure element 606. The communication device 608 can transmit the token to the reader 604 via a communication interface of the reader 604 and/or communication device 608.

The token may indicate to the reader 604 (and/or secure element 606) that the driver 610 is a valid driver participating in a mutual authentication, and may indicate to the reader 604 (and/or secure element 606) to continue the process of establishing a mutual secret key. As such, at step S628, the reader 604 can use secure element 606 to verify the driver 610 based on the validation token received at step S626, e.g., by verifying that the validation token is a legitimate validation token, using, e.g., cryptographic keys or other materials corresponding to the secure element 606 and/or the online authority computer 614, such as an online authority computer public key.

At step S630, the reader 604 and communication device 608 can establish a mutual secret key between the secure element 606 and the driver 610, using the secure element 606 and driver 610 respectively. This can be accomplished, for example, by performing a secret key exchange between the secure element 606 and driver 610 (e.g., a Diffie-Hellman key exchange), thereby establishing the mutual secret key. In some embodiments, the driver 610 can use a secure element 612 (e.g., a secure cryptoprocessor such as a trusted platform module) in order to establish the mutual secret key between the secure element 606 and the driver 610.

After establishing the mutual secret key, at step S632, the reader 604 and communication device 608 can store the mutual secret key in their respective secure elements 606 (which may be referred as a “first secure element” and which may comprise a “first secure cryptoprocessor”) and 612 (which may be referred to as a “second secure element” and may comprise a “second secure cryptoprocessor”). The reader 604 and communication device 608 can later use the mutual secret key in order to securely transmit data (e.g., credentials, as described below) between the secure element 606 and driver 610, preventing that data from being intercepted over a communication interface of the communication device 608.

As stated above, steps S634-S642 describes steps by which the reader 604 can acquire, encrypt, and transmit a credential to communication device 608, and by which the communication device 608 can decrypt the encrypt the credential using the mutual secret key and process the decrypted credential. Steps S644-S650 describe steps associated with processing operations involving an authorization computer 616, e.g., processing a payment credential in order to enact a payment transaction.

In more detail, at step S634, the reader 604 can receive a credential from the user device 602. To do so, the reader 604 may interface with the user device 602. The nature of this interfacing process can depend on the form of the user device 602 and reader 604. In some embodiments, the user device 602 can interface with the reader 604 via near field communication or by establishing physical contact between a user device interface and a reader interface. As an example, the user device 602 could be in the form of a payment card, and the user device interface could comprise surface metal contacts, such as those on EMV enabled credit cards. A Point-of-Sale (POS) terminal reader 604 could include its own surface metal contacts. By touching these two sets of surface metal contacts to one another, data (such as a credential) can be transmitted electronically between the user device 602 and the reader 604. As another alternative, for a user device 602 comprising a smartphone, physical contact could be achieved by bridging the user device 602 and reader 604 using a cable, such as a micro USB cable. As another example, the user device interface and reader interface could comprise NFC antennas, and the reader 604 could receive the credential from the user device 602 via near field communication (NFC).

In some cases, the user device 602 interfacing with the reader 604 may involve the user device 602 receiving a transmission of electrical power from the reader 604. This may be relevant if the user device 602 does not have any onboard power source. Many near field communication enabled smartcards, for example, rely on electromagnetic power from near field communication readers to power their circuitry. This transmission of electrical power may power a memory element located in the user device 602, which may be used to access and provide a credential to the reader 604.

At step S636, the reader 604 can use secure element 606 to encrypt the credential (received at step S634) using the mutual secret key, thereby producing an encrypted credential. As described above, encrypting the credential using the established mutual secret key can prevent interception of the credential as it is transmitted or otherwise provided by the secure element 606 of the reader 604 to the driver 610 of communication device 608, e.g., using USB sniffing malware that observes transmissions over a USB communication interface between the reader 604 and the communication device 608.

At step S638, the reader 604 can transmit the encrypted credential to the communication device 608 using the secure element 606. In this way, communication device 608 can receive the encrypted credential using driver 610. As described above with reference to step S636, the encrypted credential can comprise the credential received from user device 602 encrypted using the mutual secret key. The reader 604 can transmit the encrypted credential to the communication device 608 over a communication interface bridging the two devices (e.g., a communications interface as described above with reference to FIGS. 1, 4, and 6), such as a USB interface. In some embodiments, the reader 604 may comprise a component of the communication device 608 (e.g., an integrated reader) and the reader 604 may transmit (or otherwise provide to the driver 610) the encrypted credential over a communication interface comprising an internal system bus (or other appropriate internal communication interface. As described further above, drivers such as driver 610 may provide software interfaces to connected hardware devices, such as reader 604, thereby enabling the communication device 608 to access hardware functions of the reader 604 and receive data (including the credential) from the reader 604.

At step S640, the communication device 608 can use driver 610 to decrypt the encrypted credential using the mutual secret key, thereby producing the credential. In some embodiments, driver 610 can retrieve the mutual secret key from a secure element of the communication device 608 (i.e., secure element 612) in order to decrypt the encrypted credential. Alternatively, if secure element 612 comprises a secure cryptoprocessor (such as a trusted platform module), driver 610 can decrypt the encrypted credential by providing the encrypted credential to the secure element 612. The secure element 612 can then decrypt the encrypted credential using the mutual secret key and return the credential to driver 610.

At step S642, the communication device 608 can process the credential using driver 610. This processing can depend on the purpose of transmitting the credential from user device 602 to communication device 608 and the nature of the system comprising user device 602, reader 604, and communication device 608. For example, if the user device 602 comprises an ID card, used to verify the identity of a user and grant that user access to a secure building, the credential could comprise some digital form of identification (e.g., an ID number). In such a case, the communication device 608 could process the credential (using the driver 610), by comparing the credential against a “whitelist” of ID numbers corresponding to users who have access to the secure building. If the credential is among the ID numbers on the whitelist, the communication device 608 could send a signal to an electronically locked door, causing the door to unlock and granting the user access to the secure building.

As an alternative, if the user device 602 comprises a credit card possessed by a user who is attempting to perform a transaction with a merchant operator of communication device 608, then processing the credential (which may comprise a payment credential) could comprise requesting authorization for the transaction from an authorization computer 616. In such case, at step S642, the communication device 608 can generate or initiate the generation of an authorization request message based on the credential using driver 610.

Such authorization request messages can be used in payment card transactions to request authorization for a transaction. Credit card and transaction information (e.g., transaction amount, merchant name or identifier, time of transaction, credit card number, card verification value (CVV), expiration date, etc.) can be included by the communication device 608 in the authorization request message and can be routed to an issuing bank via a payment processing network (including, e.g., a processing computer, as described above) such as Visa. The credential can comprise some of this information (e.g., the credit card number, CVV, an EMV cryptogram, and expiration date). An authorization computer 616, operating by an issuing bank, can evaluate the authorization request message and generate an authorization response message (e.g., at step S646), which can be routed back to the communication device 608 in order to indicate whether the transaction has been approved or denied.

In some embodiments, the authorization request message can comprise the credential. In some embodiments, the communication device 608 can encrypt the credential using a cryptographic key associated with the authorization computer 616 (e.g., a public key associated with the authorization computer 616), thereby generating a second encrypted credential (differentiating it from a “first encrypted credential”, e.g., the encrypted credential transmitted by the reader 604 to the communication device 608 at step S638). The authorization request message can include this second encrypted credential, rather than the credential itself, in order to protect the credential as it is transmitted to the authorization computer 616 over a potentially insecure communication network, such as the Internet.

The processing of step S642 can additionally comprise steps S644-S650. At step S644, the communication device 608 can use the driver 610 to transmit the authorization request message to the authorization computer 616. In some embodiments, the communication device 608 can transmit the authorization request message somewhat directly (e.g., via a network such as the Internet) to the authorization computer 616. However, in other embodiments, the authorization computer 616 may be part of a broader system, such as a four-party network used to process payment transactions. In such a case, the authorization request message may be transmitted through a series of intermediary computers and devices before reaching the authorization computer 616 at step S644.

For example, the communication device 608 can transmit the authorization request message to a transport computer, which can comprise a computer system associated with an acquirer bank that maintains a payment account for a merchant operator of the communication device 608. Subsequently, the transport computer can transmit the authorization request message to a processing computer. Afterwards, the processing computer can transmit the authorization request message to the authorization computer 616.

The processing computer can comprise a server computer that is part of a processing network, which may regularly process large amounts of payment card transactions. One function of the processing computer can comprise identify acquiring banks and issuer banks and their respective computer systems (e.g., a transport computer and the authorization computer 616). After identifying their intended recipients, the processing computer can forward authorization request messages to the corresponding authorization computers for authorization. In doing so, the processing computer can enable a transfer of funds from an account corresponding to the user to an account corresponding to a resource provider, thereby enabling users and resource providers to complete transactions.

To perform this function, the processing computer may analyze authorization request messages and use information contained therein to identify relevant authorization computers (and transport computers). For example, for a credential comprising a credit card number, the first few digits of the credential may comprise a “bank identification number” (BIN) which may identify an issuer bank, enabling the processing computer to route the authorization request message to an authorization computer (e.g., authorization computer 616) associated with that issuing bank.

At step S646, the authorization computer 616 can authorize or deny the authorization request message. In doing so, the authorization computer 616 can generate an authorization response message, which can indicate whether some interaction (e.g., a transaction) has been approved or denied. The authorization computer 616 may have its own logic or procedures for authorizing interactions. For example, the authorization computer 616 may compute a risk score based on a variety of data included in the authorization request message, then authorize or deny the interaction based on the risk score.

The authorization computer 616 can transmit the authorization response message back to the communication device 608, either directly, or e.g., via a processing computer and a transport computer, as described above with reference to step S644. Any of the computers or devices in the “chain of transmission” between the authorization computer 616 and the communication device 608 can interpret the authorization response message as necessary. These transmissions may occur via any suitable communication network (e.g., the Internet) and may conform to any suitable communication protocol (e.g., ISO 8583, a protocol for communicating payment information). Regardless, at step S648 the communication device 608 can use the driver 610 to receive the authorization response message.

As stated above, the communication device 608 may be operated by a resource provider (e.g., a merchant or an employee of a merchant), who may wish to determine whether or not they should provide some resource (e.g., consumer goods) to a user of user device 602, and who therefore may wish to know whether the interaction (e.g., transaction) has been approved or denied. The communication device 608 may interpret the authorization response message and display some message (e.g., on a screen of the communication device 608) indicating whether the interaction has been approved or denied.

Afterwards, at step S650 the communication device 608 can perform (or otherwise enact) an interaction in response to receiving the authorization response message. Such an interaction can depend largely on the context or use case for the system comprising the reader 604 and communication device 608. For a system for processing credit card transactions, a resource provider merchant can either provide a user with purchased goods or services (e.g., if the authorization response message indicates that the transaction has been approved) or not (e.g., if the authorization response message indicating that the transaction has not been approved). As another example, for a building access control system, a resource provider could either allow a user to access the building or could prevent the user from accessing the building, depending on the authorization response message.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

Some descriptive statements in this application can be interpreted in view of the operating principles of a computer system, and additionally in view of their relevance to methods according to embodiments. For example, a statement such as “the driver 414 can receive an encrypted credential from the secure element 428 of the reader 404” may include a situation where the communication device 402 now has access to the encrypted credential, and can use the driver 414 in order to operate on that encrypted credential (e.g., can use driver 414 to decrypt the encrypted credential using mutual secret key 422).

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
establishing, by a communication device, a mutual secret key between a driver of the communication device and a secure element of a reader associated with the communication device;
receiving, by the driver of the communication device from the reader, an encrypted credential, wherein the reader received a credential from a user device and encrypted the credential using the mutual secret key to produce the encrypted credential;
decrypting, by the communication device, using the driver, the encrypted credential using the mutual secret key thereby producing the credential; and
processing, by the communication device, using the driver, the credential.

2. The method of claim 1, wherein the mutual secret key is established based on a token, and wherein the method further comprises, prior to establishing the mutual secret key between the driver and the secure element:
reading, by the communication device, using the driver, a public key, a digital signature, and a secure element identifier associated with the secure element; and
providing, by the communication device, using the driver, to an online authority computer, the secure element identifier, the digital signature, and the public key, wherein the online authority computer validates the digital signature and provides a token to the communication device via the driver.

3. The method of claim 2, wherein the online authority computer is associated with a manufacturer of the reader and/or the secure element.

4. The method of claim 1, wherein the secure element comprises a component of the reader, wherein the secure element includes a secure memory, and wherein the secure memory stores the mutual secret key.

5. The method of claim 4, wherein the secure element is a first secure element, wherein the secure memory is a first secure memory, and wherein the method further comprises:
storing, by the communication device, the mutual secret key in a second secure memory of a second secure element.

6. The method of claim 5, wherein the second secure element comprises a secure cryptoprocessor, and wherein the secure cryptoprocessor comprises a trusted platform module (TPM).

7. The method of claim 1, wherein the reader is connected to the communication device via a communication interface of the communication device.

8. The method of claim 7, wherein the communication interface includes one or more of the following:
a USB interface;
an I2C interface;
an SPI interface;
a SATA interface;
a PCI or PCIe interface;
an Ethernet interface; and
a Bluetooth interface.

9. The method of claim 1, wherein the reader comprises a near-field communication (NFC) reader configured to receive data from user devices via NFC.

10. The method of claim 1, wherein the reader comprises a component of the communication device.

11. The method of claim 1, wherein the user device is in a form of a card.

12. The method of claim 1, wherein the communication device is a mobile phone.

13. The method of claim 1, wherein the credential is an account identifier.

14. The method of claim 1, wherein processing comprises initiating generating, or generating, an authorization request message with the credential.

15. A method comprising:
establishing, by a reader, using a secure element, a mutual secret key between a driver of a communication device and the secure element;
receiving, by the reader, a credential from a user device;
encrypting, by the reader, using the secure element, the credential using the mutual secret key, thereby producing an encrypted credential; and
transmitting, by the reader, using the secure element, the encrypted credential to the communication device, wherein the communication device decrypts the encrypted credential using the driver and the mutual secret key, thereby producing the credential, and wherein the communication device processes the credential using the driver.

16. The method of claim 15, wherein the reader comprises a component of the communication device.

17. The method of claim 15, wherein:
the reader establishes the mutual secret key between the driver and the secure element based on a token;
the method further comprises:
providing, by the reader, using the secure element, to the driver, a public key, a digital signature, and a secure element identifier associated with the secure element, wherein the communication device uses the driver to provide the public key, the digital signature, and the secure element identifier to an online authority computer, wherein the online authority computer validates the digital signature and provides the token to the communication device via the driver, and
receiving, by the reader, using the secure element, from the communication device, the token; and
wherein establishing, by the reader, using the secure element, the mutual secret key between the driver and the secure element comprises:
verifying, by the reader, using the secure element, the driver based on the token, and
performing, by the reader, using the secure element, a secret key exchange with the driver, thereby establishing the mutual secret key.

18. A communication device comprising:
one or more processors; and
a non-transitory computer readable medium coupled to the one or more processors, the non-transitory computer readable medium comprising instructions, executable by the one or more processors to implement a method comprising:
establishing a mutual secret key between a driver of the communication device and a secure element of a reader associated with the communication device;
receiving, by the driver of the communication device, from the reader, an encrypted credential, wherein the reader received a credential from a user device, and encrypted the credential using the mutual secret key to produce the encrypted credential;
decrypting, using the driver, the encrypted credential using the mutual secret key, thereby producing the credential; and
processing, using the driver, the credential.

19. The communication device of claim 18, wherein, in the method, the mutual secret key is established between the driver and the secure element based on a token, and wherein the method further comprises, prior to establishing the mutual secret key between the driver and the secure element:
reading, using the driver, a public key, a digital signature, and a secure element identifier associated with the secure element; and
providing, using the driver, to an online authority computer, the secure element identifier, the digital signature, and the public key, wherein the online authority computer validates the digital signature and provides a token to the communication device via the driver.

20. The communication device of claim 18, wherein the communication device further comprises the reader, the secure element, and a near-field communication (NFC) antenna, wherein, in the method, the reader receives the credential from the user device using the near-field communication (NFC) antenna.
